(19) United States
(12) Patent Application Publication
(10) Pub. No.: US 2004/0256509 A1
(43) Pub. Date: Dec. 23, 2004

(54) Shredder cutter having multiple, offset cutter picks

(76) Inventor: John P. Dorscht, Sarnia (CA)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/856,246

(22) Filed: May 28, 2004

Related U.S. Application Data
(60) Provisional application No. 60/473,463, filed on May 28, 2003.

(51) Int. Cl. G03B 1/58

(52) U.S. Cl. 242/332.4

(57) ABSTRACT

A cutter for a rotary shredder has a cutter tip which is divided into separate first and second picks which are mounted side by side on the cutter. The picks have offset leading edges so one pick reaches the material being shredded before the other pick. The picks also may have different profiles, which causes them to shred the material in a different manner.

### RELATED APPLICATIONS

This application claims the benefit under 35 USC §119(e) of Provisional Application Ser. No. 60/473,463, filed May 28, 2003.

### BACKGROUND AND SUMMARY OF THE INVENTION

Waste reduction shredders utilize cutters mounted on a rotating shaft to shred material fed into the shredder. In many applications it is common to use a pick and shear cutter having pointed picks which engage and break the material. A shredder blade of this type is shown in Torp, U.S. Pat. No. 4,993,648. It also is common for shredder cutters to have replaceable teeth, as shown in Sears, U.S. Pat. No. 6,375,108.

Pick and shear cutters typically have a small number of picks, often only one, which reduces their shredding efficiency. A single pick must be quite large and sturdy to withstand the stresses caused by the shredding, which means the penetration and breaking force is spread over a relatively large area. In addition, replacement of cutter teeth is a time-consuming process, which causes shredder down time and thus reduces shredder efficiency.

The subject invention overcomes the foregoing shortcomings of prior art shredders by providing a cutter with a cutter tip having multiple picks which are mounted on the cutter side by side. The picks have leading edges which are offset from one another. In another preferred embodiment the picks also have different profiles.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a perspective view of a cutter for a rotary shredder embodying the subject invention.

FIG. 2 is a plan view of the cutter of FIG. 1.

FIG. 3 is a perspective view of a shaft with cutters of the subject invention installed on it.

FIG. 4 is a perspective view of the cutter of FIG. 1, showing how the tips are mounted on it.

### DETAILED DESCRIPTION OF THE PREFERRED EMBODIMENT

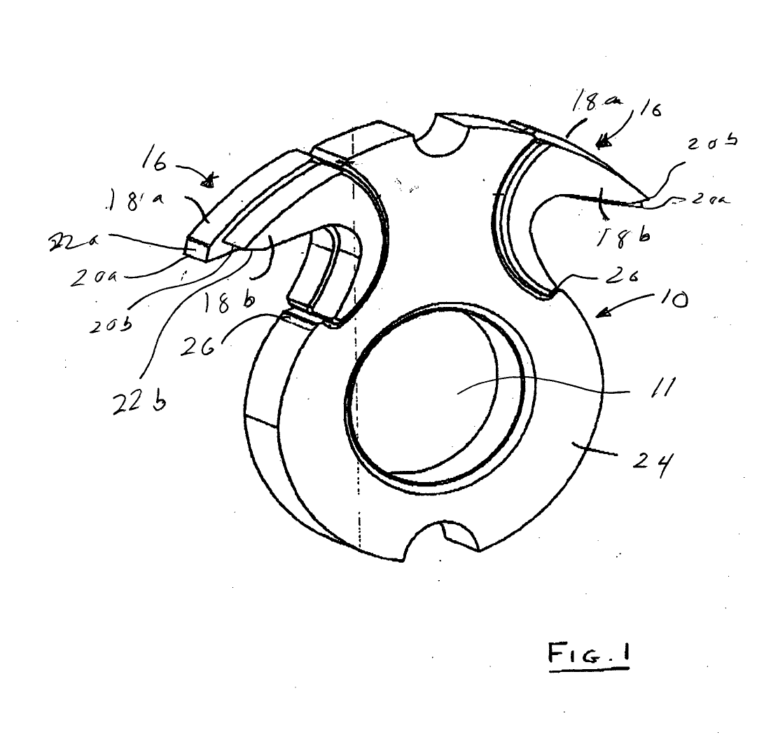

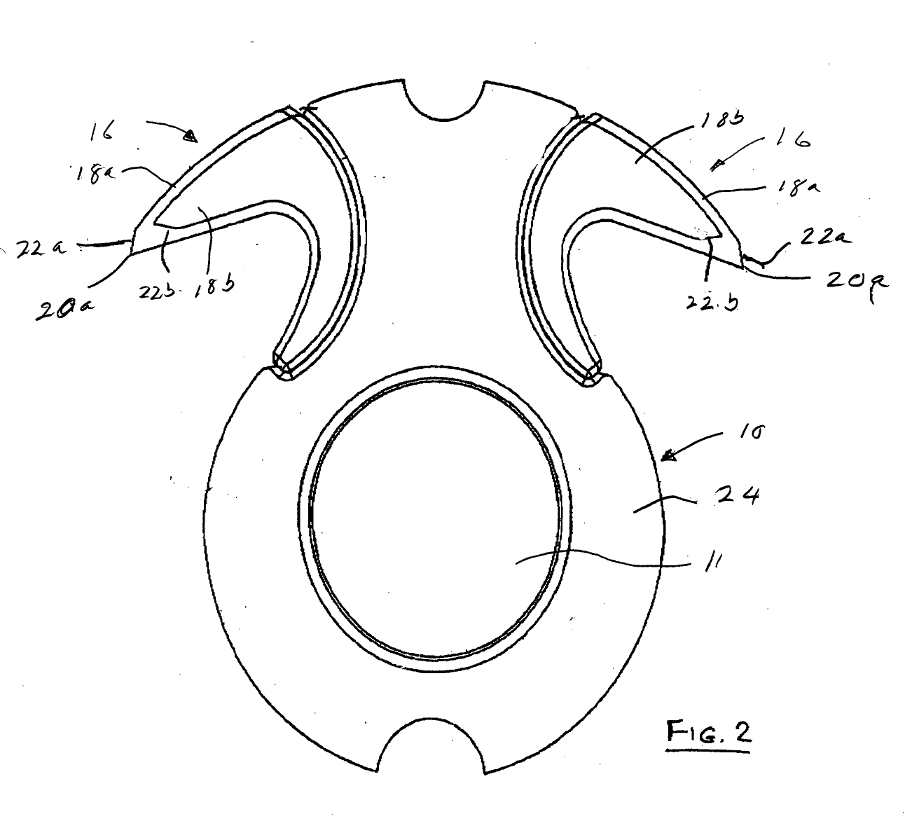

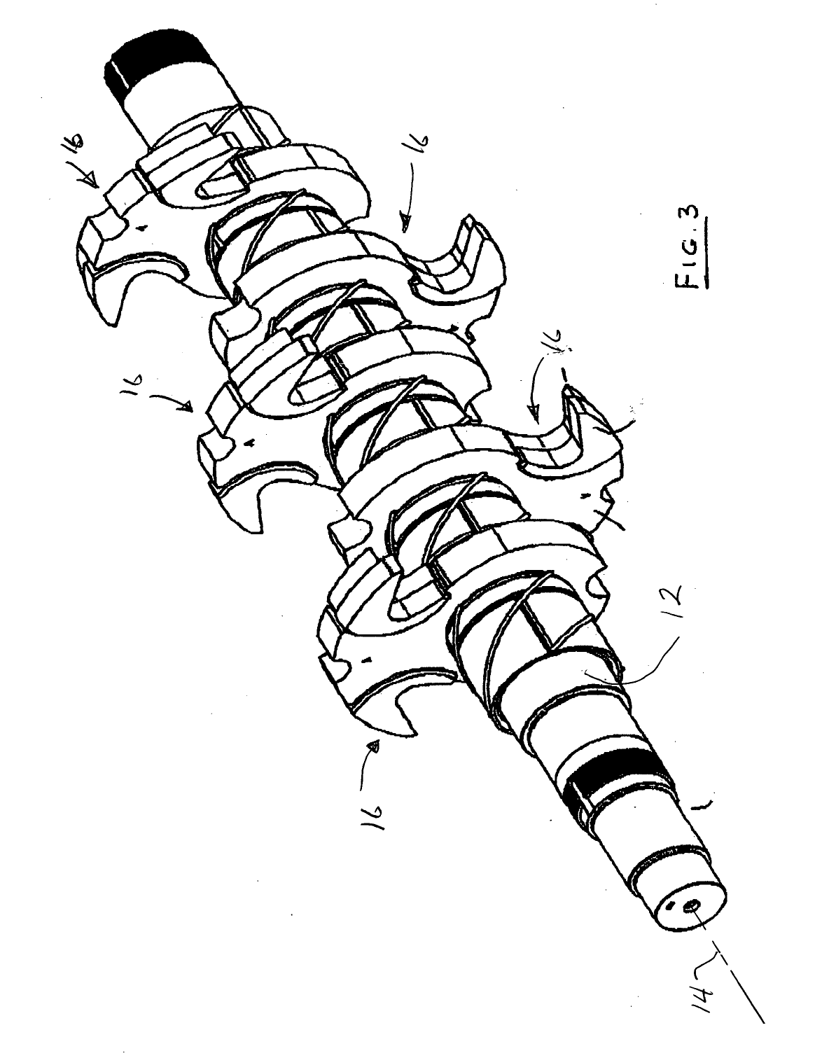

Referring now to FIGS. 1, 2 and 3 of the drawings, a cutter for a rotary shredder includes a cutter blade 10 which has a central opening 11 that allows it to be mounted on a shaft 12 having a rotational axis 14. The cutter blade is fixed on the shaft so that it rotates with the shaft. In the embodiment illustrated in FIG. 3, there are five cutter blades mounted on the shaft, but the number of cutter blades is not important and there could be more or less.

Located on the cutter blade 10 is a tip 16 which penetrates and tears material being shredded. In the embodiment illustrated the cutter blade has two tips, one which strikes material being shredded when the shaft is rotated in a clockwise direction and one which strikes material when the shaft is rotated in a counterclockwise direction. This allows the rotation of the shredder to be reversed to clear jammed material. The cutter blade could only have a single tip 16, if desired.

The tip 16 is separated into multiple picks. The drawings show and the Description Of The Preferred Embodiment refers to two picks, a first pick 18a and a second pick 18b, however, there could be more than two picks. The picks 18a and b are located side by side. The first pick 18a has a first leading edge 20a and the second pick 18b has a second leading edge 20b. The first leading edge 20a is offset from the second leading edge 20b, however both leading edges preferably are the same radial distance from the axis of rotation 14. Thus, when the shaft is rotated the first leading edge contacts a piece of material being shredded before the second leading edge does, however, because the two picks are side by side and their leading edges are at the same radial distance from the center line of the shaft, both picks generally will contact the same piece of material.

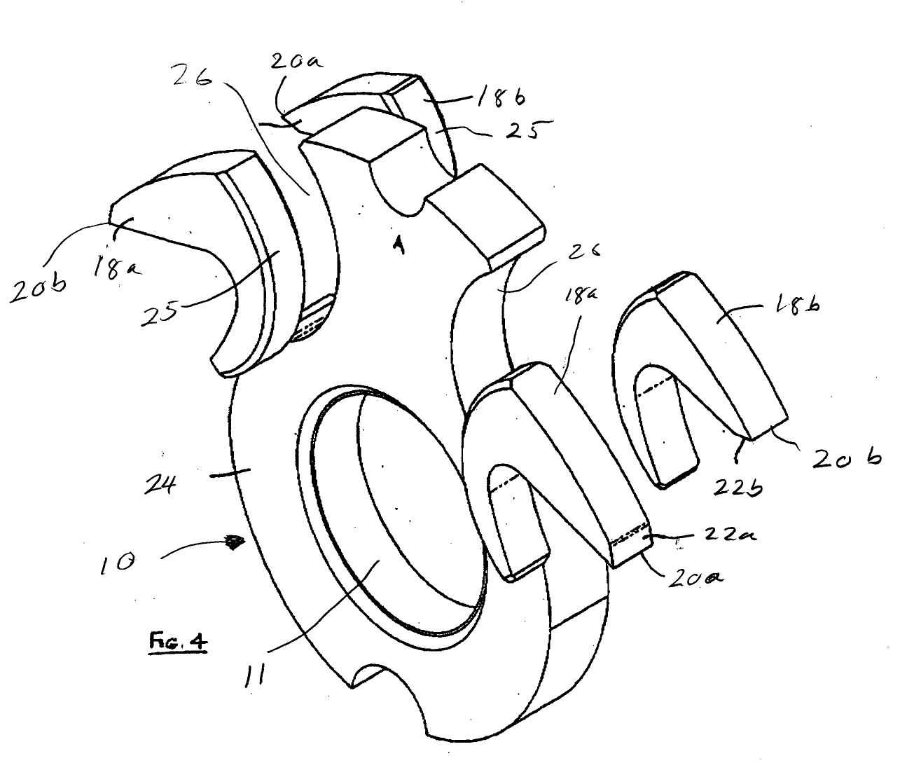

The first leading edge 18a has a first profile and the second leading edge 18b has a second profile which is different from the first profile. In the preferred embodiment illustrated both leading edges are wedge-shaped, but the first leading edge has a radially outwardly-facing cutting face 22a and the second leading edge 20b has a radially inwardly-facing cutting face 22b. The picks are removably attached to the body 24 of the cutter blade. The back sides 25 of the picks are curved and fit into a conforming notch 26 in the body 24. Each pick 18a and b is a separate element which is separately attached to the body 24, FIG. 4. Attachment can either be by welding, as shown in the drawings, or by bolting.

The use of multiple side-by-side picks with offset leading edges has several advantages. Because the leading edge of the first pick strikes the piece of material being shredded before the leading edge of the second pick, essentially the entire torque of the shredder is applied to each pick, the front pick having essentially shattered the piece of material before the second piece strikes it. It also creates different and diverging fracture lines in the material. In addition, the outwardly facing face 22a of the first pick and the inwardly facing face 22b of the second pick causes the material to be split in opposite directions. Together this results in the material being shredded into smaller particles than would be the case with a one-piece pick.

Having the cutter tip 16 divided into two picks also means that the majority of the wear occurs in the first pick 18a. As a result the first pick can be replaced more frequently than the second pick at a considerable cost savings compared to replacing a one-piece pick. In addition, it is easier to replace one piece of a two-piece pick than a one-piece pick because the piece not being replaced acts as a reference surface to index the pick being replaced. Thus, in addition to providing more efficient shredding, the cutter of the subject invention is less costly to maintain.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A cutter for a shredder comprising:
(a) A cutter tip having a first pick and a second pick, said first and second picks being mounted side by side;
(b) said first pick having a first leading edge, and said second pick having a second leading edge, said first leading edge being offset from said second leading edge;

2. The cutter of claim 1 wherein said first leading edge has a first profile and said second leading edge has a second profile which is different from said first profile.

3. The cutter of claim 1 wherein said cutter tips are separately removably attached to the remainder of said cutter.

4. The cutter of claim 1 wherein said cutter is capable of being mounted on a shaft for rotation with the shaft around a rotational axis, and said first and second picks are located on the cutter such that when the shaft is rotated said first leading edge is rotationally ahead of said second leading edge.

5. The cutter of claim 4 wherein said first leading edge has an angled cutting face which faces radially outwardly with respect to the rotational axis and said second leading edge has an angled cutting face which faces radially inwardly with respect to the rotational axis.

6. The cutter of claim 4 wherein the first and second leading edges are radially equal distance from the rotational axis.

7. A shredder cutter comprising:
(a) a cutter blade which is mountable on a shaft having a rotational axis for rotation with the shaft;
(b) a cutter tip located on said cutter blade;
(c) said cutter tip having a plurality of side-by-side picks, each pick having a leading edge which is offset from the leading edge of each adjacent pick.

8. The cutter of claim 7 wherein the leading edge of at least some of said picks have profiles which are different from the profile of at least some other of said picks.

9. The cutter of claim 7 wherein said picks are separately removably mounted on said cutter blade.

10. The cutter of claim 7 wherein the leading edges of all of said picks are equal distance from said rotational axis.

11. A shredder cutter which is mountable on a shaft for rotation with the shaft comprises a plurality of side-by-side picks, each pick having a leading edge, said picks being arranged such that the leading edges of at least some of said picks are rotationally ahead of the leading edges of others of said picks when the shaft is rotated.

12. A shredder cutter mountable on a shaft for rotation with the shaft comprises a plurality of side-by-side picks, each pick having a leading edge, said picks being mounted side by side on the cutter with the leading edges of at least some of said cutter picks being offset from the leading edges of other cutter picks.
